(19) United States
(12) Patent Application Publication
(10) Pub. No.: US 2013/0203456 A1
(43) Pub. Date: Aug. 8, 2013

(54) MOBILE COMMUNICATION METHOD AND MOBILE STATION

(71) Applicants: Wuri Andarmawanti Hapsari, Chiyoda-ku (JP); Mikio Iwamura, Chiyoda-ku (JP)

(72) Inventors: Wuri Andarmawanti Hapsari, Chiyoda-ku (JP); Mikio Iwamura, Chiyoda-ku (JP)

(73) Assignee: NTT DOCOMO, INC., Tokyo (JP)

(21) Appl. No.: 13/817,265

(22) PCT Filed: Aug. 12, 2011
(86) PCT No.: PCT/JP2011/068420

§ 371 Date: Apr. 19, 2013

(30) Foreign Application Priority Data
Aug. 16, 2010 (JP) 2010-181883

(51) Int. Cl. H04W 24/00

(52) U.S. Cl. CPC H04W 24/00
USPC 455/517

(57) ABSTRACT

A mobile communication method according to the present invention includes a step A of generating and storing, by a mobile station UE in a standby state, a MDT log including predetermined information in a period defined by a “Logged MDT measurement period”, a step B of generating and storing, by the mobile station UE, the MDT log when a standby cell is changed, and a step C of transmitting, by the mobile station UE, the stored MDT log to a radio base station eNB after the mobile station UE is changed to an active state.

### TECHNICAL FIELD

The present invention relates to a mobile communication method and a mobile station.

### BACKGROUND ART

In an LTE (Long Term Evolution) scheme, “MDT (Minimisation of Drive Tests)” is defined.

According to the MDT, in “Logged MDT”, a mobile station UE is configured to measure “Periodic DL Pilot Strength” in a period defined by a “Logged MDT measurement period”, and generate and store a MDT log including a result of the measurement.

### CITATION LIST

### Non Patent Literature

[NPL 1] 3GPP TR36.805

[NPL 2] 3GPP TS37.320

### SUMMARY OF INVENTION

### Technical Problem

However, in the conventional “Logged MDT”, there is a problem that it is not sufficient to realize “Coverage Optimisation” only through the “Periodic DL Pilot Strength” measured by the mobile station UE.

Therefore, the present invention has been achieved in view of the above-described problems, and an object thereof is to provide a mobile communication method and a mobile station, by which it is possible to acquire information required for realizing “Coverage Optimisation” in “Logged MDT”.

### Solution to Problem

A first characteristic of the present embodiment is summarized in that a mobile communication method includes: a step A of generating and storing, by a mobile station in a standby state, log information including predetermined information in a predetermined period; a step B of generating and storing, by the mobile station, the log information when a standby cell is changed; and a step C of transmitting, by the mobile station, the stored log information to a radio base station after the mobile station is changed to an active state.

A second characteristic of the present embodiment is summarized in that a mobile station includes: a management unit that generates and stores log information including predetermined information in a predetermined period when the mobile station is in a standby state; and a transmission unit that transmits the stored log information to a radio base station after the mobile station is changed to an active state, wherein, when the mobile station changes a standby cell, the management unit is configured to generate and store the log information.

### Advantageous Effects of Invention

As described above, according to the present invention, it is possible to provide a mobile communication method and a mobile station, by which it is possible to acquire information required for realizing “Coverage Optimisation” in “Logged MDT”.

### BRIEF DESCRIPTION OF DRAWINGS

FIG. 1 is a diagram illustrating the entire configuration of a mobile communication system according to a first embodiment of the present invention.

FIG. 2 is a functional block diagram of a mobile station according to the first embodiment of the present invention.

FIG. 3 is a diagram for explaining the operation of the mobile communication system according to the first embodiment of the present invention.

### DESCRIPTION OF EMBODIMENTS

(Mobile Communication System According to First Embodiment of the Present Invention)

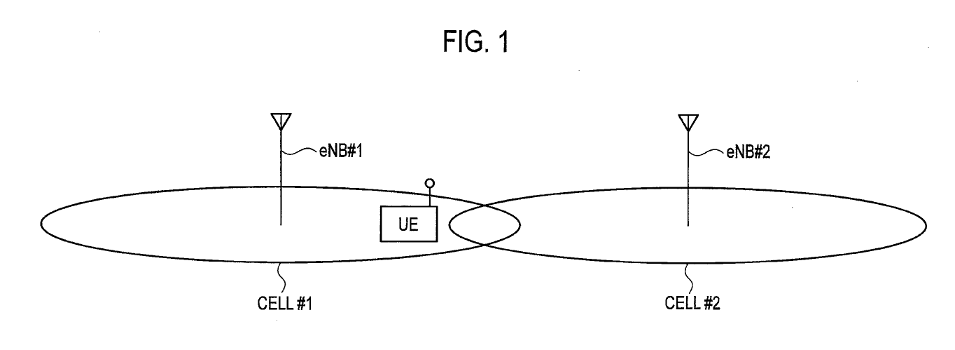

With reference to FIG. 1 to FIG. 3, a mobile communication system according to a first embodiment of the present invention will be described.

As illustrated in FIG. 1, the mobile communication system according to the present embodiment is an LTE mobile communication system, and includes a radio base station eNB#1 configured to manage a cell #1 and a radio base station eNB#2 configured to manage a cell #2.

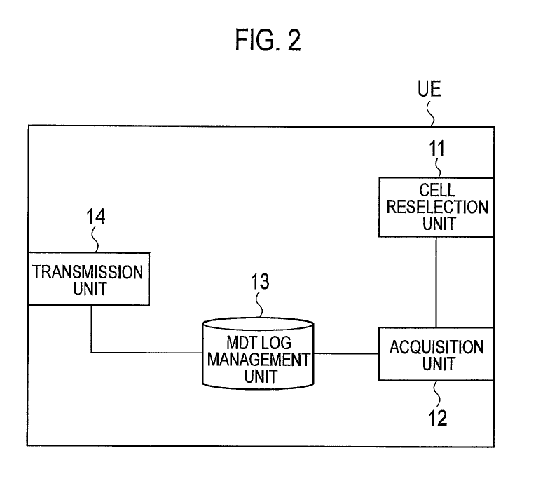

A mobile station UE according to the present embodiment is able to cope with “Logged MDT”, and includes a cell reselection unit 11, an acquisition unit 12, an MDT log management unit 13, and a transmission unit 14 as illustrated in FIG. 2.

The cell reselection unit 11 is configured to perform cell reselection and change a standby cell when a predetermined condition is satisfied.

The acquisition unit 12 is configured to acquire predetermined information required for generating a MDT log.

For example, the acquisition unit 12 is configured to acquire, as the predetermined information, “RSRP (Reference signal Received Power)” and “RSRQ (Reference signal Received Quality)”, which are radio quality in a predetermined cell, “Time Stamp”, “Location Information” and the like.

Furthermore, the acquisition unit 12 may be configured to acquire radio quality in a cell (a frequency), which is designated by a radio base station eNB based on “MDT Configuration”, as the radio quality in the predetermined cell.

In addition, the acquisition unit 12 may be configured to acquire the

“Location Information” and the radio quality in the predetermined cell at different timings.

Furthermore, when the standby cell is changed by the cell reselection unit 11, the acquisition unit 12 is configured to acquire, as the predetermined information, “E-CGI (E-UTRAN Cell Global Identifier)” and “PCI (Physical Cell Identity)”, which are identification information of a changed standby cell, radio quality (RSRP, RSRQ and the like) in the changed standby cell, and the like.

When the mobile station UE is in a standby state (an RRC-Idle state), the MDT log management unit 13 is configured to generate and store a MDT log including the predetermined information acquired by the acquisition unit 12, in a period defined by a “Logged MDT measurement period”.

Furthermore, when the mobile station UE performed the cell reselection, that is, when the standby cell is changed by the cell reselection unit 11, the MDT log management unit 13 is configured to generate and store the MDT log including the predetermined information acquired by the acquisition unit 12.

In such a case, after the time point at which the changed standby cell is initially selected, the MDT log management unit 13 might be configured to generate and store the MDT log in the period defined by the “Logged MDT measurement period”.

The transmission unit 14 is configured to transmit the MDT log stored in the MDT log management unit 13 to a radio base station eNB after the mobile station UE is changed to an active state (an RRC_Connected state).

Furthermore, the transmission unit 14 is configured to transmit the MDT log stored in the MDT log management unit 13 at the request of a radio base station eNB that manages a cell in which the mobile station UE is changed to the active state.

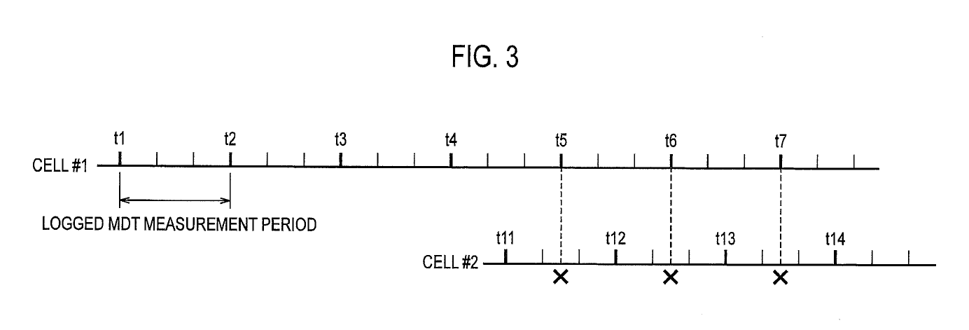

Hereinafter, with reference to FIG. 3, an example of the operation of the mobile communication system according to the first embodiment of the present invention will be described.

When the cell #1 is set as a standby cell, the mobile station UE acquires the aforementioned predetermined information at time points t1, t2, t3, and t4 (in an example of FIG. 3) in the period defined by the “Logged MDT measurement period”, and generates and stores the aforementioned MDT log.

For example, at the time points t1, t2, t3, and t4, the mobile station UE generates and stores a MDT log including radio quality in the cell #1, “Time Stamp”, and “Location Information”.

Furthermore, at the time t11, the mobile station UE performs cell reselection to change a standby cell from the cell #1 to the cell #2, and generates and stores a MDT log including “E-CGI” and “PCI” of the cell #2, radio quality in the cell #2, “Time Stamp”, and “Location Information”.

Then, after the time point t11 at which the cell #2 (the changed standby cell) is initially selected, the mobile station UE generates and stores a MDT log in the period defined by the “Logged MDT measurement period”. Furthermore, at the time t11, the mobile station UE may generate and store the MDT log, or may not generate and store the MDT log.

That is, instead of generating and storing the MDT log at times t5, t6, and t7, the mobile station UE may generate and store the MDT log at times t12, t13, and t14.

In accordance with the mobile communication system according to the first embodiment of the present invention, in the “Logged MDT”, in addition to a MDT log including “Periodic DL Pilot Strength”, since the mobile station UE is configured to generate and store a MDT log including “E-CGI” and “PCI” of a changed standby cell, radio quality in the changed standby cell, “Time Stamp”, and “Location Information” when the standby cell is changed, a communication provider is able to collect information required for realizing “Coverage Optimisation” in the “Logged MDT”.

The characteristics of the present embodiment as described above may be expressed as follows.

A first characteristic of the present embodiment is summarized in that a mobile communication method includes: a step A of generating and storing, by a mobile station UE in a standby state, a MDT log (log information) including predetermined information in a period (a predetermined period) defined by a “Logged MDT measurement period”; a step B of generating and storing, by the mobile station UE, the MDT log when a standby cell is changed; and a step C of transmitting, by the mobile station UE, the stored MDT log to a radio base station eNB after the mobile station UE is changed to an active state.

In the first characteristic of the present embodiment, in the step B, the mobile station UE may generate and store, as the predetermined information, the log information including at least one of identification information (E-CGI, PCI and the like) of a changed standby cell, radio quality (RSRP, RSRQ and the like) in the changed standby cell, “Time Stamp (time information)”, and “Location Information (location information)”.

In the first characteristic of the present embodiment, after the time point at which the changed standby cell is initially selected, the mobile station UE may generate and store the MDT log in the period defined by the “Logged MDT measurement period”.

A second characteristic of the present embodiment is summarized in that a mobile station UE includes: a MDT log management unit 13 configured to generate and store a MDT log including predetermined information in a period defined by a “Logged MDT measurement period” when the mobile station UE is in a standby state; and a transmission unit 14 configured to transmit the stored MDT log to a radio base station eNB after the mobile station UE is changed to an active state, wherein when the mobile station UE changed a standby cell (performed cell reselection), the MDT log management unit 13 is configured to generate and store the MDT log.

In the second characteristic of the present embodiment, the MDT log management unit 13 may be configured to generate and store, as the predetermined information, the MDT log including at least one of identification information (E-CGI, PCI and the like) of a changed standby cell, radio quality (RSRP, RSRQ and the like) in the changed standby cell, “Time Stamp”, and “Location Information”.

In the second characteristic of the present embodiment, after the time point at which the changed standby cell is initially selected, the MDT log management unit 13 may be configured to generate and store the MDT log in the period defined by the “Logged MDT measurement period”.

In addition, the operation of the above-mentioned radio base station eNB or mobile station UE may be implemented by hardware, may also be implemented by a software module executed by a processor, or may further be implemented by the combination of the both.

The software module may be arranged in a storage medium of an arbitrary format such as a RAM (Random Access Memory), a flash memory, a ROM (Read

Only Memory), an EPROM (Erasable Programmable ROM), an EEPROM (Electronically Erasable and Programmable ROM), a register, a hard disk, a removable disk, or a CD-ROM.

The storage medium is connected to the processor so that the processor can write and read information into and from the storage medium. Such a storage medium may also be accumulated in the processor. Such storage medium and processor may be arranged in an ASIC. Such an ASIC may be arranged in the radio base station eNB or the mobile station UE. As a discrete component, such storage medium and processor may be arranged in the radio base station eNB or the mobile station UE.

Thus, the present invention has been explained in detail by using the above-mentioned embodiments; however, it is obvious that for persons skilled in the art, the present invention is not limited to the embodiments explained herein.

The present invention can be implemented as a corrected and modified mode without departing the gist and the scope of the present invention defined by the claims. Therefore, the description of the specification is intended for explaining the example only and does not impose any limited meaning to the present invention.

### REFERENCE SIGNS LIST

UE . . . Mobile station
eNB . . . Radio base station
11 . . . Cell reselection unit
12 . . . Acquisition unit
13 . . . MDT log management unit
14 . . . Transmission unit

1. A mobile communication method comprising:
a step A of generating and storing, by a mobile station in a standby state, log information including predetermined information in a predetermined period;
a step B of generating and storing, by the mobile station, the log information when a standby cell is changed; and
a step C of transmitting, by the mobile station, the stored log information to a radio base station after the mobile station is changed to an active state.

2. The mobile communication method according to claim 1, wherein, in the step B, the mobile station generates and stores, as the predetermined information, the log information including at least one of identification information of a changed standby cell, radio quality in the changed standby cell, time information, and location information.

3. The mobile communication method according to claim 1, wherein, after a time point at which a changed standby cell is initially selected, the mobile station generates and stores the log information in the predetermined period.

4. A mobile station comprising:
a management unit that generates and stores log information including predetermined information in a predetermined period when the mobile station is in a standby state; and
a transmission unit that transmits the stored log information to a radio base station after the mobile station is changed to an active state, wherein
when the mobile station changes a standby cell, the management unit is configured to generate and store the log information.

5. The mobile station according to claim 4, wherein the management unit is configured to generate and store, as the predetermined information, the log information including at least one of identification information of a changed standby cell, radio quality in the changed standby cell, time information, and location information.

6. The mobile station according to claim 4, wherein, after a time point at which a changed standby cell is initially selected, the management unit is configured to generate and store the log information, in the predetermined period.
